(19) United States
(12) Patent Application Publication
(10) Pub. No.: US 2016/0364838 A1
(43) Pub. Date: Dec. 15, 2016

(54) Side-by-Side Dash Display for Boats and Methods Therefor

(71) Applicant: Fineline Industries, LLC, Merced, AZ (US)

(72) Inventor: Shane STILLMAN, LaGrand, AZ (US)

(73) Assignee: Fineline Industries, LLC, Merced, CA (US)

(21) Appl. No.: 15/180,827

(22) Filed: Jun. 13, 2016

Related U.S. Application Data
(60) Provisional application No. 62/174,812, filed on Jun. 12, 2015.

(51) Int. Cl. G06T 3/20; G06T 11/00; B63B 49/00; G06F 3/14

(52) U.S. Cl. CPC G06T 3/20; G06F 3/1431; G06T 11/00; B63B 49/00

(57) ABSTRACT

A display on a boat's dash enables the driver to display desired data in easy-to-read format while the boat is underway. Two screens adjacent to each other are separated by a mullion. In its initial state, the display shows a speedometer split across the screens. Additional data can be displayed on the screens along with the speedometer portions. The boat driver presses a button on the display causing the speedometer to move to the left and in doing so the speedometer portions appear to move together under the mullion to form a whole speedometer on the left screen. Moving the speedometer to one screen frees display area on the other so that additional or different data can be displayed. By pressing certain buttons on the display any already-displayed additional data may remain on the screen or disappear, and different additional data may be added to the screens.

### CROSS-REFERENCE TO RELATED APPLICATIONS

This application claims the benefit of co-pending U.S. Provisional Application No. 62/174,812 filed Jun. 12, 2015.

### FIELD OF INVENTION

The present invention relates generally to the user interface of a data display system. This invention relates particularly to a dashboard display for a boat that enables the user to reformat the display across two screens for easier viewing of desired data.

### BACKGROUND

Modern performance boats for wakesurfing, wakeboarding and slalom waterskiing require the driver's attention to many details including the boat's speed, engine status, fuel status, wake-shaping equipment status, and others. Historically this information has been displayed on an instrument panel with multiple separate displays, dials, and switches making for a complex array of fixed dials in the boat's cockpit. The complexity and small size of the read-outs made viewing the data difficult while the boat was underway. More modern boats use a single electronic display monitor on the dashboard in the boat's cockpit for some of the desired information. However, the combination of a large amount of information and limited dash space for a display monitor still makes viewing of the desired data difficult while underway because the display is too small to show all the desired data at a size that is viewable while driving the boat.

It would be desirable to provide a display on a boat's dash that enables the boat driver to easily see desired data while underway.

### SUMMARY OF THE INVENTION

It is an object of this invention to provide a display on a boat's dash that enables the boat driver to display desired data in ways that are easy to read while the boat is underway. This invention enables the user to reformat the displayed data on-the-fly for easier viewing. This boat's dashboard display uses two screens adjacent to each other in a side-by-side arrangement, separated by a mullion. Preferably the screens are touch screens. In its initial state, the display shows a speedometer split across the screens such that one half of the speedometer is on the left screen and one half is on the right screen. Additional data can be displayed on the screens along with the speedometer portions. The boat driver can press a button on the display causing the speedometer to move to the left and in doing so the speedometer portions appear to move together to form a whole speedometer on the left screen. Similarly, the boat driver can press a button on the display causing the speedometer to move to the right and in doing so the speedometer portions appear to move together to form a whole speedometer on the right screen. Moving the speedometer to one screen frees display area on the other so that additional or different data can be displayed. By pressing certain buttons on the display or touching the screens any already-displayed additional data may remain on the screen or disappear, and different additional data may be added to the screens. In this way the boat driver can reformat the displayed data on-the-fly for easier viewing of desired data.

### BRIEF DESCRIPTION OF THE DRAWINGS

FIG. 1 is a schematic illustration of a front view of a side-by-side display of the present invention in a first state, implemented in a dash of a boat.

FIGS. 2A-D is a schematic illustration of a side-by-side display with a center feature transitioning from a split view to a whole view on the left.

FIGS. 3A-D is a schematic illustration of a side-by-side display with a center feature transitioning from a split view to a whole view on the right.

FIGS. 4A-D is a schematic illustration of a side-by-side display with a center feature transitioning from a split view to a whole view on the left, along with additional displaying data.

FIGS. 5A-D is a schematic illustration of a side-by-side display a center feature transitioning from a split view to a whole view on the right, along with additional images displaying data.

FIGS. 6A-D is a detailed illustration of a side-by-side display with a combination speedometer-tachometer transitioning from a split view to a whole view on the left.

FIGS. 7A-D is a detailed illustration of a side-by-side display with a combination speedometer-tachometer transitioning from a split view to a whole view on the right.

FIG. 8 is a graphic illustration of a HOME screen.

FIG. 9A is a graphic illustration of a GPS screen.

FIG. 9B is a graphic illustration of the left screen of FIG. 9A with additional GPS data displayed.

FIG. 10 is a graphic illustration of a DIAG screen.

FIG. 11 is a graphic illustration of a MENU screen.

FIG. 12 is a graphic illustration of a BALLAST screen.

FIG. 13 is a graphic illustration of a RIDER screen.

FIG. 14 is a graphic illustration of a SURF screen.

FIG. 15 is a graphic illustration of a SWITCH screen.

### DETAILED DESCRIPTION OF THE INVENTION

This invention is a display housed in a vehicle's dashboard 9 that enables a user to control how various vehicle parameters are displayed. The invention is discussed as embodied in a boat, but may be employed in the dashboard of any vehicle.

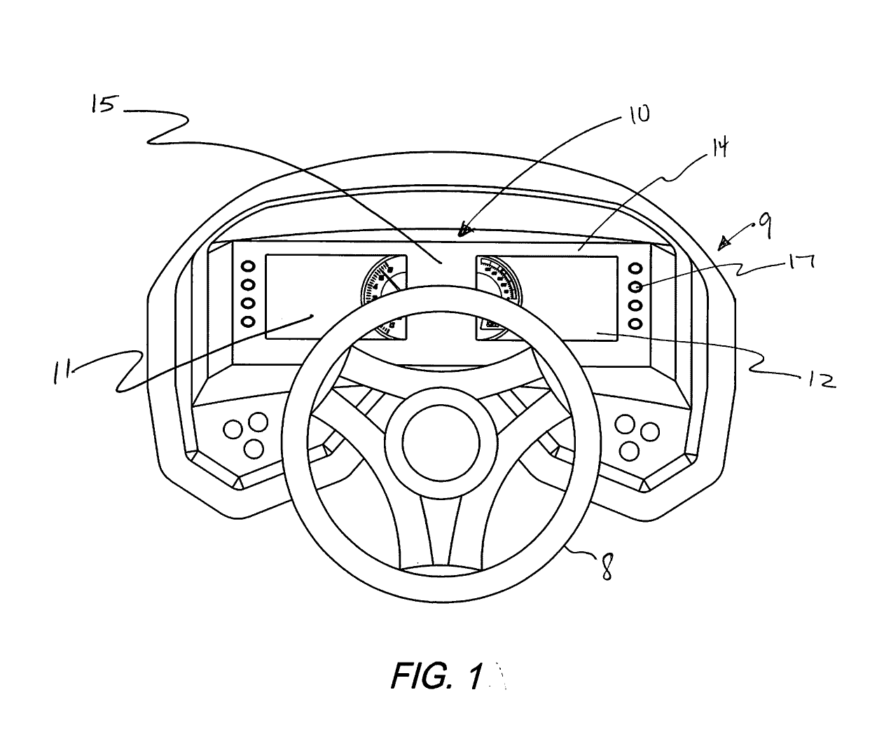

FIG. 1 shows the present invention, generally referred to as display 10, housed in a boat dashboard 9, also referred to herein as a dash. FIG. 1 shows the display 10 as viewed from the driver's position as he faces the steering wheel 8. Any type of data can be displayed, such as data relating to the boat's performance, equipment status, and location. Typically the data of most interest is that available from the boat's instruments and controls such as the boat's speed, direction, and attitude; fuel status; battery status; engine rpms, temperature, and oil pressure; wake-shaping equipment status including wake plate position, wake fin position, and ballast tank fill levels; wake-rider data including navigation, docking and underwater lights on/off; seat heater on/off; swim step up/down; GPS position, map location, time of day, water temperature and depth; air temperature and wind speed, cruise control on/off; profile name; and stereo controls. Displaying all desired data in a size readable by the driver while operating the boat has heretofore been impossible because the dash of a boat is too small to easily display the data at a size that is viewable while driving a performance boat.

To solve that problem, the display 10 of the present invention comprises two or more electronic screens, also known in the art as display monitors, adjacent to each other. The screens are in communication with electronic components that receive the data that is displayed and that control the displays, as known to those skilled in the art of boat instruments and equipment and electronic displays. Such electronic components include integrated and discrete circuits forming CPUs, graphics processing units, video display controllers, video display processors, and the like. The boat data displayed on the screens is real-time data, and the display changes as the data changes.

The screens can be arranged by stacking them vertically in a top-to-bottom arrangement, but preferably they are arranged horizontally side-by-side because they fit better since a dashboard's width in the horizontal direction is typically greater than the height in the vertical direction. For the purposes of describing the preferred embodiment, two screens are used and are identified as a left screen 11 and a right screen 12. If instead arranged vertically the screens would be more accurately identified as a top screen and a bottom screen.

The screens are fitted with a frame 14 that cooperates with the screens to visually separate them with an area in which no information is electronically displayed. In the preferred embodiment the frame 14 is an opaque piece of plastic or other material and the portion that runs between the left screen 11 and the right screen 12 is referred to herein as a mullion 15. Alternatively the screens may be configured electronically to appear to have a mullion by displaying a static image, including displaying a blank image, at the edges of the screens where they meet. For example, the left screen may display a vertical bar at its right side and the right screen may display a vertical bar at its left side so that the black bars together create the look of a mullion. Alternatively a wider single screen may be configured to appear to have two separate screens by displaying a static image, including displaying a blank image, between the left and right sides of the screen. Preferably the screens are touch screens.

The screens can display all data available at a large enough size to be easily readable while the boat is underway, although not necessarily at the same time. This flexibility is achieved by enabling the user to reformat the display across two screens for desired data, while hiding other data. In some cases the transition from one set of data to the next occurs in stages that make it appear that the dials on the display are moving. For example, the initial state of the display 10 shows a center feature 16 split across the screens such that one half of the center feature 16 is on the left screen 11 and the other half of the center feature 16 is on the right screen 12. See FIGS. 1, 2A, 3A, 4A, 5A, 6A, 7A, and 8. In actuality, an electronic image is being rendered on the left screen 11 and a different electronic image is being rendered on the right screen 12 such that the image shown on the display 10 appears to be a center feature 16 split across the two screens and passing under the mullion 15 between the screens. Moving the displayed data in this way enables two small screens having a relatively small viewing area to have the functional equivalent of a much larger viewing area.

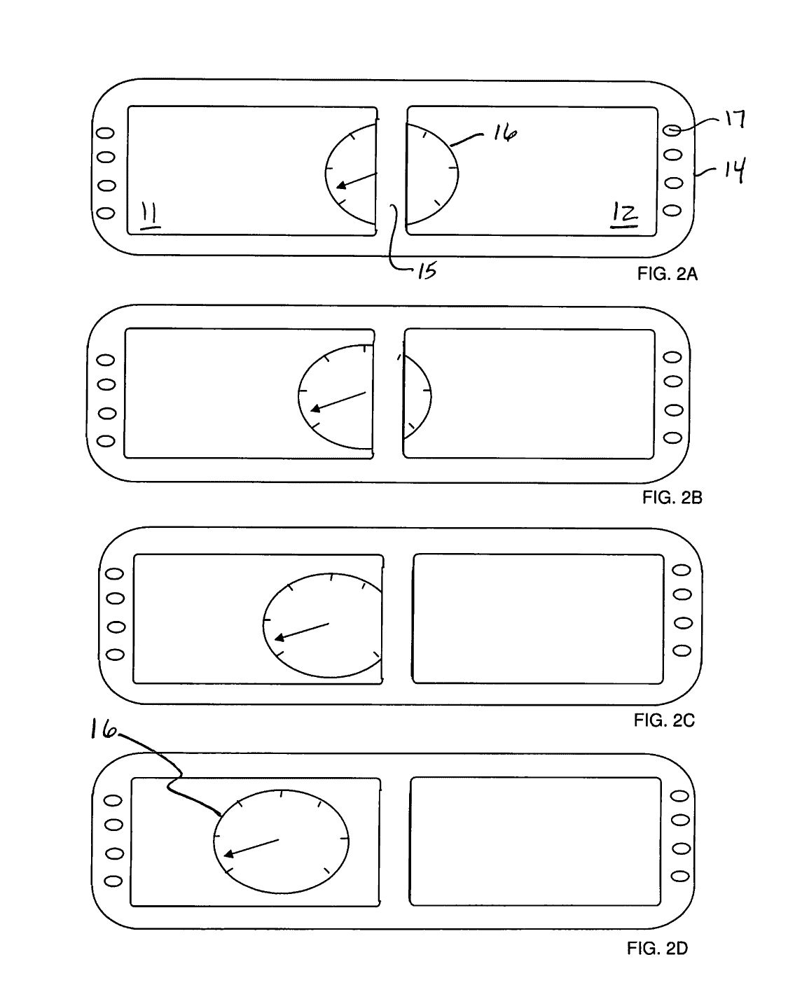

The boat driver can press a button on the display 10 causing the center feature 16 to move to a second state in which a whole center feature 16 appears on the left screen. See FIGS. 2D, 4D, and 6D. Intermediate states between the first state and the second state can be displayed in which portions of the center feature 16 image are shown on the first and second screens such that they make it appear as if the center feature 16 portions are sliding together across the first and second displays. See FIGS. 2A-D, 4A-D and 6A-D. Although two intermediate states are shown in the figures, any number of intermediate states may be used.

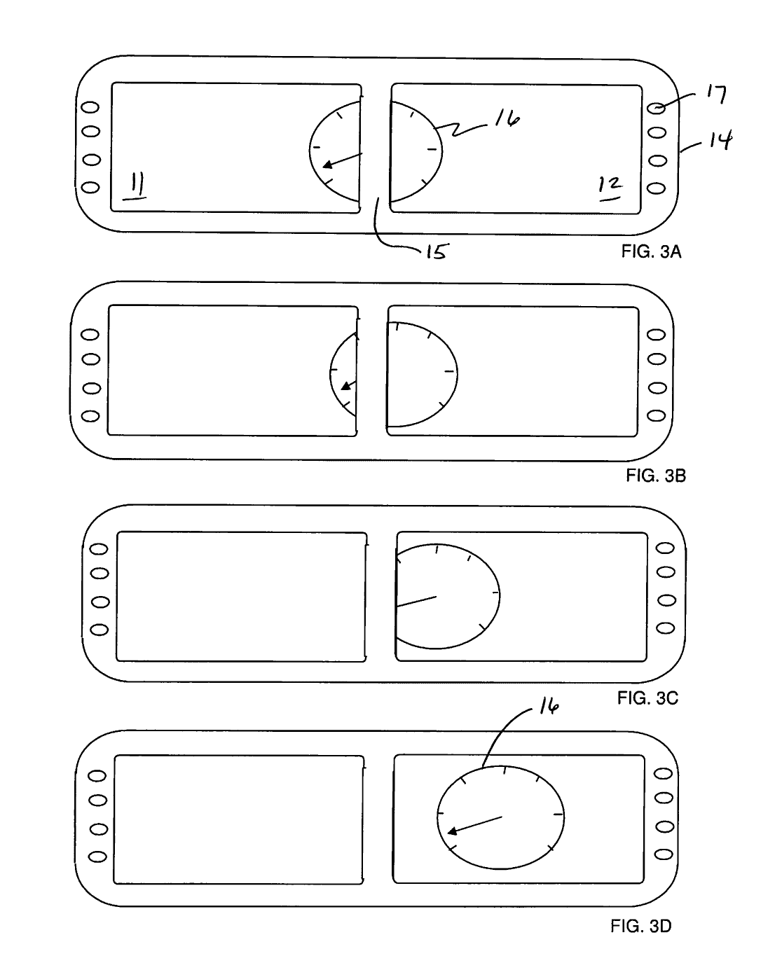

Similarly boat driver can press a button on the display causing the center feature 16 to move to a second state in which a whole center feature 16 appears on the right screen. See FIGS. 3D, 5D, 7D and 9A. Intermediate states between the first state and the second state can be displayed in which portions of the center feature 16 image are shown on the first and second screens such that they make it appear as if the center feature 16 portions are sliding together across the first and second displays. See FIGS. 3A-D, 5A-D and 7A-D. Although two intermediate states are shown in the figures, any number of intermediate states may be used.

The center feature 16 may be a dial or dials. The feature appears a continuous dial through which an arm of the dial moves, when in reality the movement of the arm is proportional to an electronic measurement of the parameter being measured. For example, if the feature is a speedometer the arm moves around the dial in one direction as the speedometer receives an electronic signal that the boat is moving faster and the arm moves in the other direction as the speedometer receives an electronic signal that the boat is moving slower. In the preferred embodiment, the center feature 16 is a speedometer 30. In the initial state one half of the speedometer 30 is on the left screen 11 and the other half of the speedometer 30 is on the right screen 12. See FIGS. 2A and 3A, for example. In actuality, an electronic image of a portion of the speedometer 30 is being rendered on the left screen 11 and a different electronic image of a different portion of the speedometer 30 is being rendered on the right screen 12 such that the image shown on the display 10 appears to be a speedometer split across the two screens and passing under the mullion 15 between the screens.

The boat driver can press a button on the display causing speedometer 30 to move to the left and in doing so the speedometer 30 portions move together to form the image of a whole speedometer 30 on the left screen 11. Similarly, the boat driver can press a button on the display 10 causing the speedometer 30 to move to the right and in doing so the speedometer 30 portions move together to from a whole speedometer 30 on the right screen 12. Additional data can be displayed on the screens in addition to the speedometer 30 portions as described in more detail below.

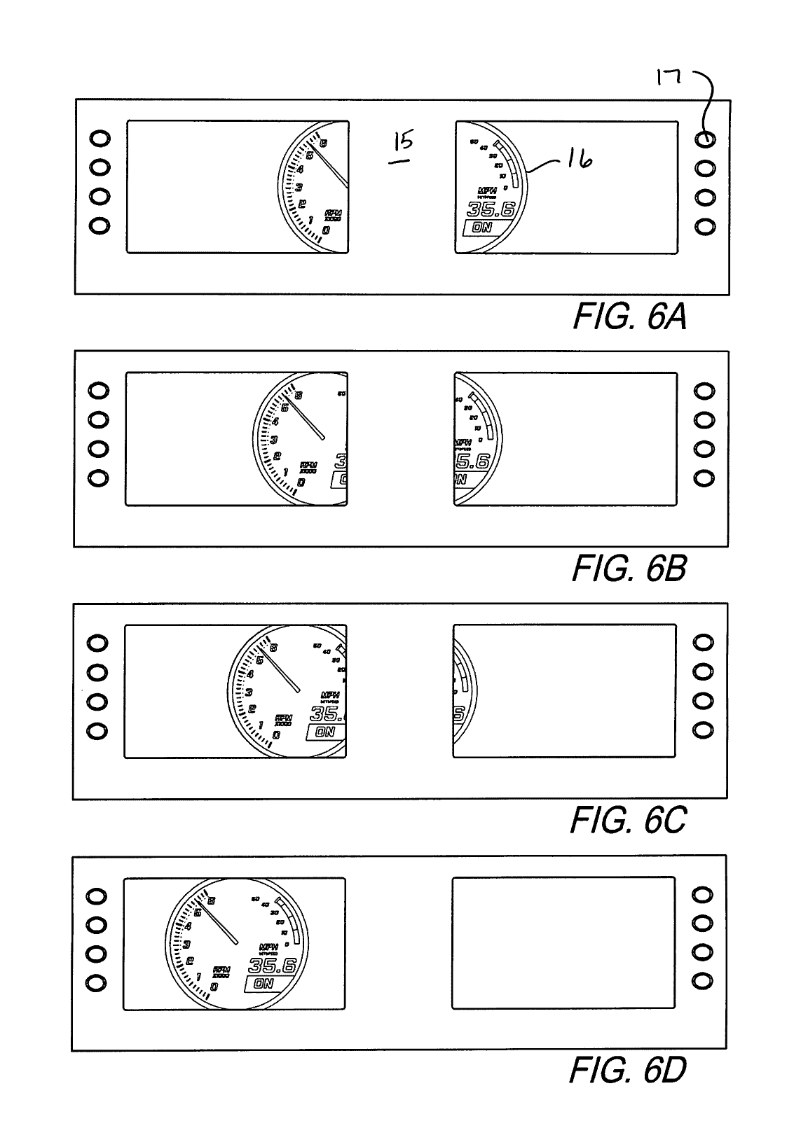

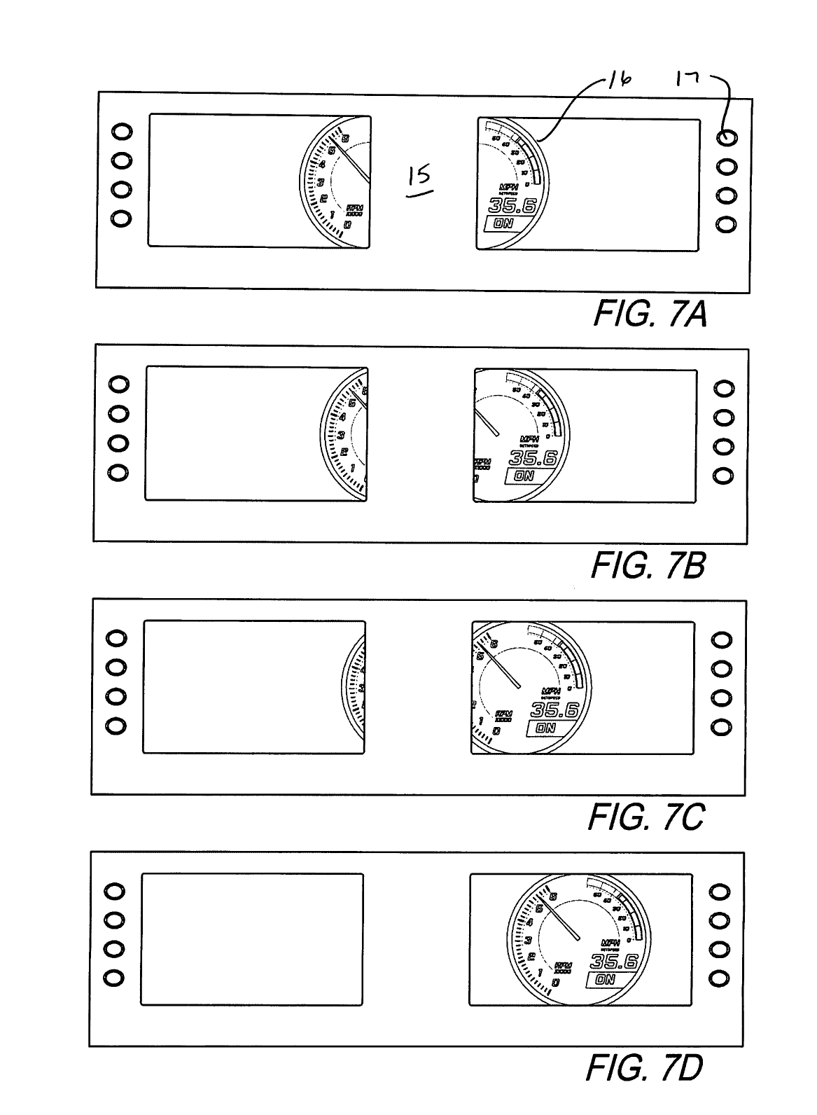

In another embodiment, the center feature 16 is a speedometer and tachometer combination. See FIGS. 6A-D and 7A-D. In this embodiment, in the initial state of the display 10 shows the speedometer-tachometer 31 split across the screens such that one half of the combination is on the left screen 11 and the other half is on the right screen 12. As shown in FIGS. 6-7, the left half is a tachometer and the right half is the speedometer. In actuality, an electronic image is being rendered on the left screen 11 and a different electronic image is being rendered on the right screen 12 such that the image shown on the display 10 appears to be a speedometer-tachometer 31 split across the two screens and passing under the mullion 15 between the screens.

The boat driver can press a button on the display 10 causing the combination speedometer-tachometer 31 to move to the left and in doing so the combination speedometer-tachometer 31 portions move together to from a whole combination speedometer-tachometer 31 on the left screen 11. Similarly, the boat driver can press a button on the display causing the combination speedometer-tachometer 31 to move to the right and in doing so the combination speedometer-tachometer 31 portions move together to from a whole combination speedometer-tachometer 31 on the right screen 12.

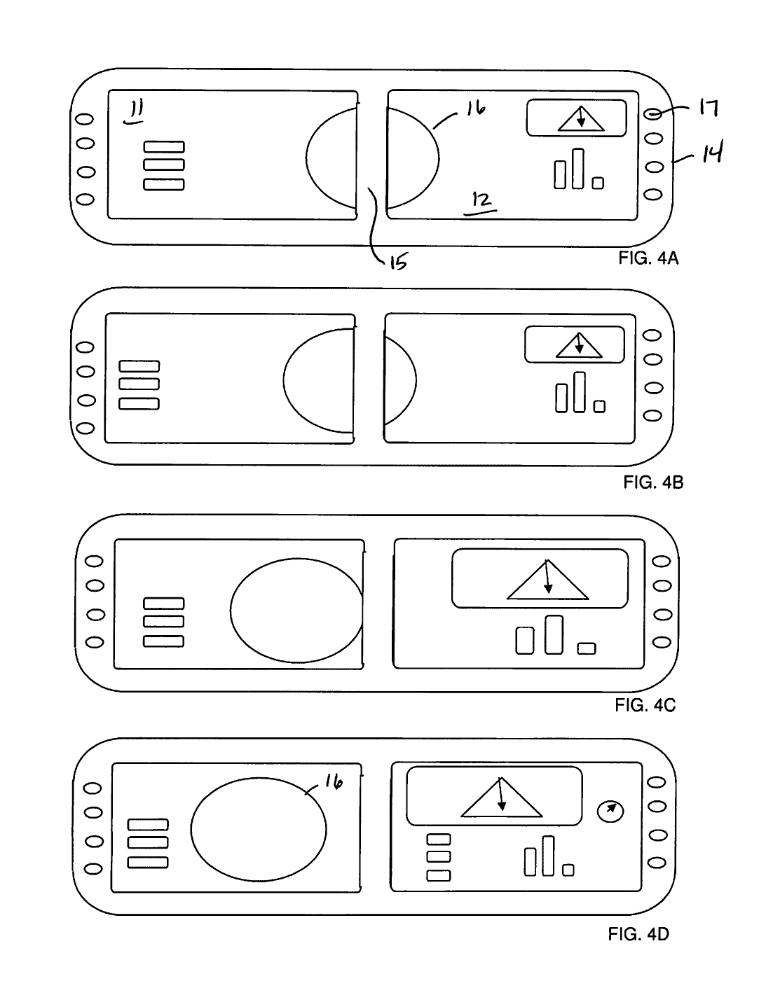

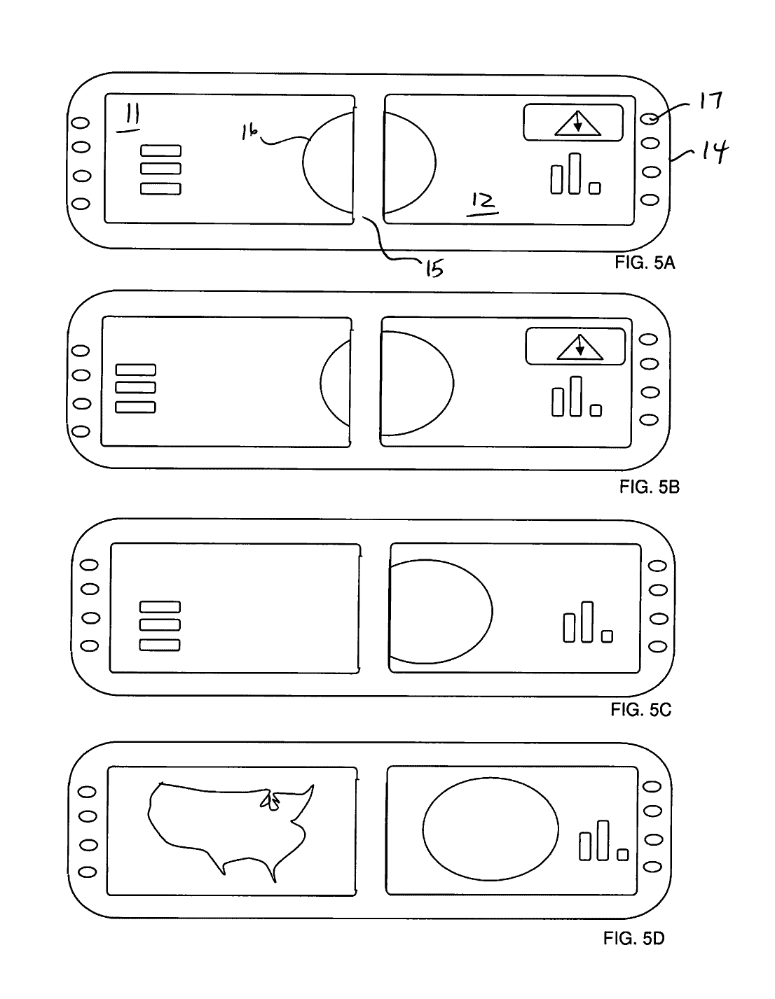

Additional data can be displayed on the screens along with the portions of the center feature 16. See FIGS. 4A and 5A, for example. To display additional data, the boat driver can touch a screen or press a button 17 embedded in the frame 14 or dashboard 9, causing the display 10 to change. By pressing certain buttons on the display or touching the screens, any already-displayed additional data may remain on the screen or disappear, and different data may be added to the screens. In this way the boat driver is able to reformat the displayed data on-the-fly for easier viewing of desired data.

In a preferred embodiment there are four mechanical buttons 17 that are disposed in or on the frame 14 surrounding the left screen 11 and four more mechanical buttons disposed in or on the frame 14 surrounding the right screen 12. See e.g. FIGS. 1, 8 and 9. For clarity in the drawings only one of the buttons around the screens is identified with a numeral. Instead of or in addition to the mechanical buttons, the display change can be implemented with electronic buttons. If the screens are touch screens simply touching the screen at the right location will cause the display to change, in effect touching an electronic button. As used herein “pressing a button” means to trigger a display change with either a mechanical button or an electronic one.

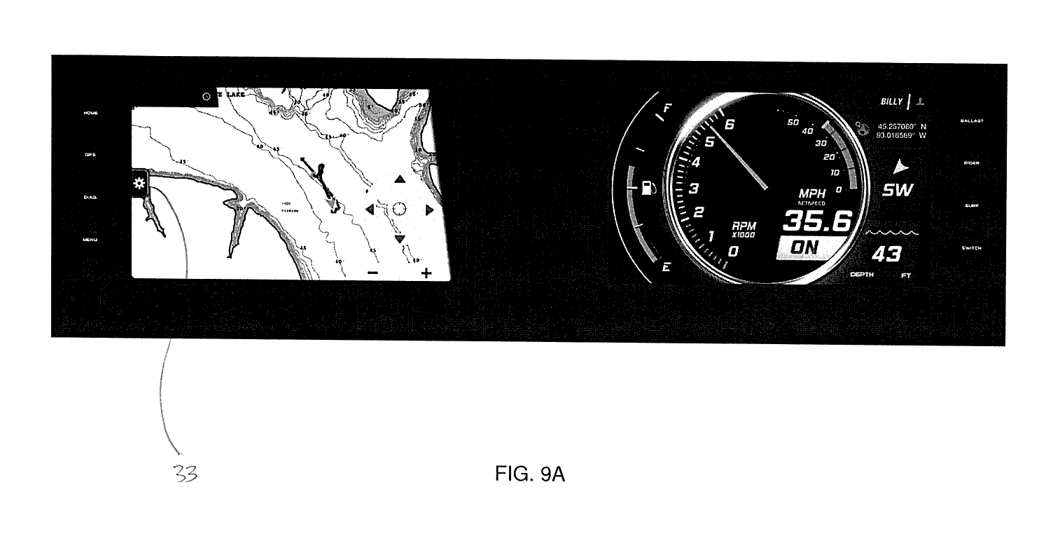

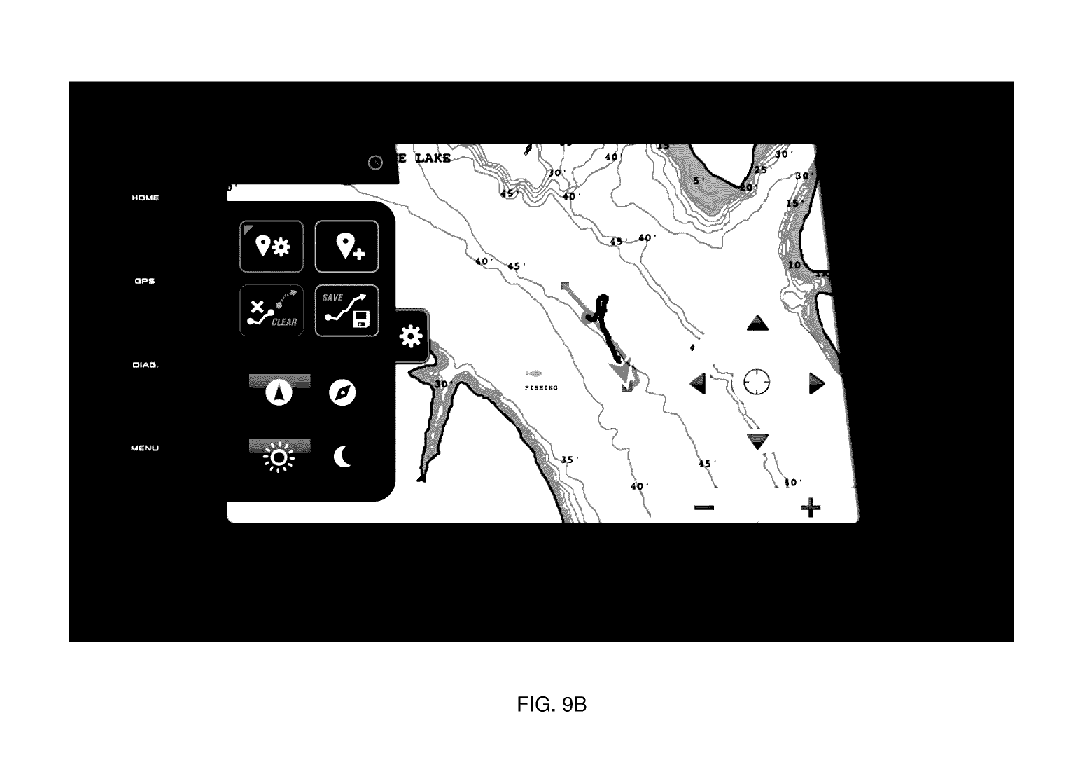

Each button is labeled for the general type of data it causes to be displayed. In one preferred embodiment the four buttons on the frame of the left screen 11 are labeled HOME, GPS, DIAG, and MENU from top to bottom, respectively. See, e.g., FIG. 9A-B. Pressing a given button causes the display to change so that it shows additional or different parameters.

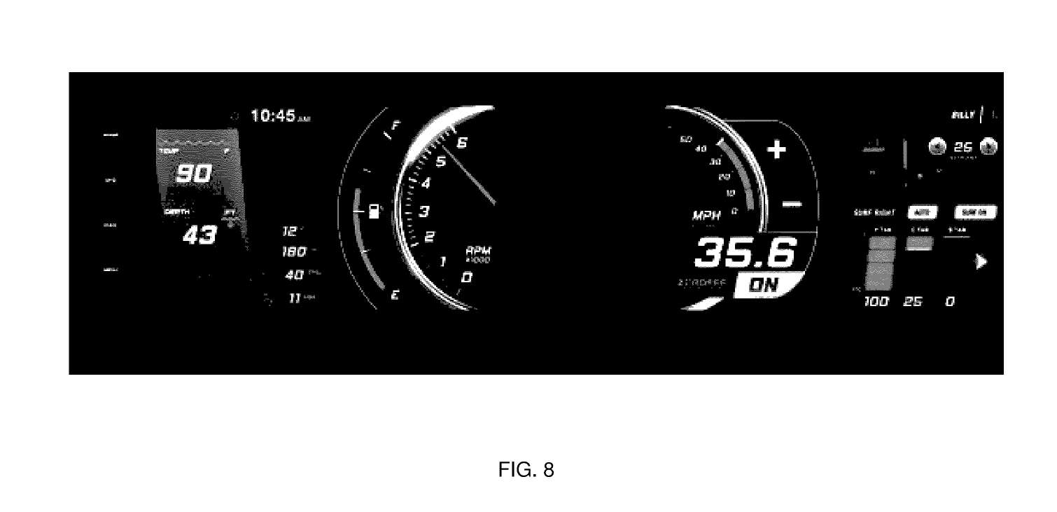

In one example pressing the HOME button causes a certain set of data to be displayed. See FIG. 8. The speedometer-tachometer 31 is centered between both screens with cruise control on the right screen 12. The left screen 11 includes engine related data, water temp and water depth (with depth histogram), time and dedicated telltales such as mil lamp, low depth, low fuel indicators. When the center feature 16 slides to the left screen, the right screen 12 will display ballast and control data. Wake equipment data will also be displayed on the right screen. For Centurion® boats this includes Quick control/display for Centurion Articulating Tracking System known as CATS™, basic Tab/Surf control/display, switching and rider presets and profile name.

If the GPS button is pressed, the speedometer-tachometer 31 slides to the right and GPS data including lat/long and heading are displayed on the left screen 11. See FIG. 9A. Icons on the touchscreen enable the driver to display additional data. For example, if the gear button 30 is pressed, additional icons, controls and data will be displayed over a map on the left screen 11. See FIG. 9B.

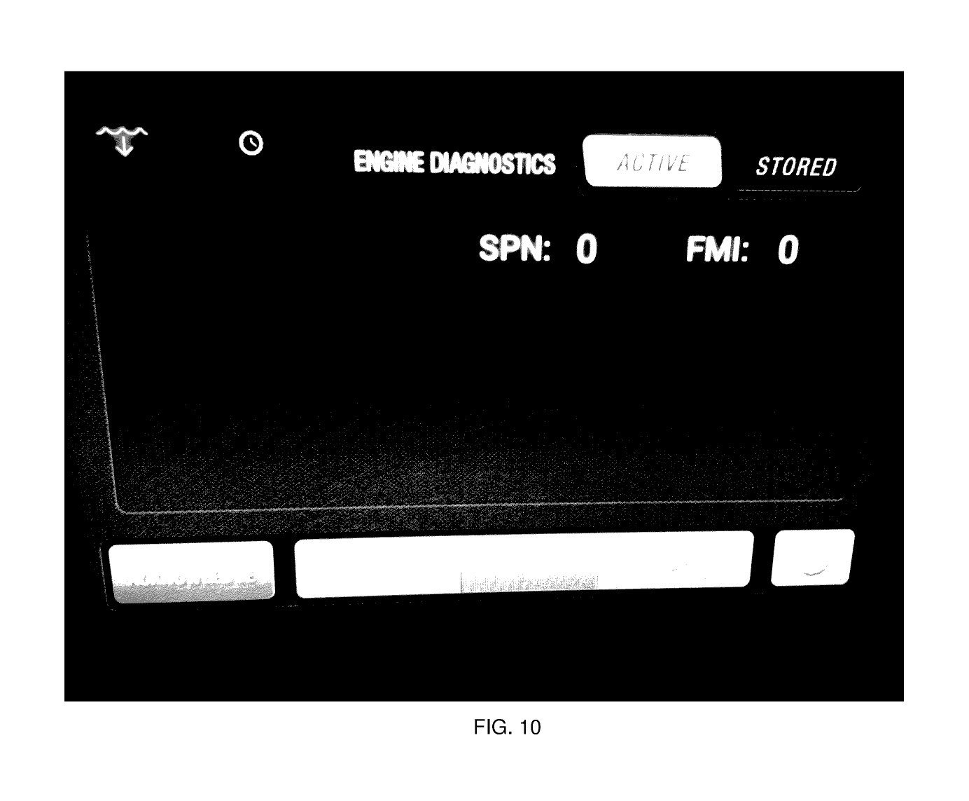

If the DIAG button is pressed, the speedometer-tachometer 31 will slide to the right screen along with engine data, water temp and depth. See FIG. 10. The left screen is then dedicated to displaying data about engine diagnostics, both active and stored) including trouble codes on the engine such as SMI and FMI.

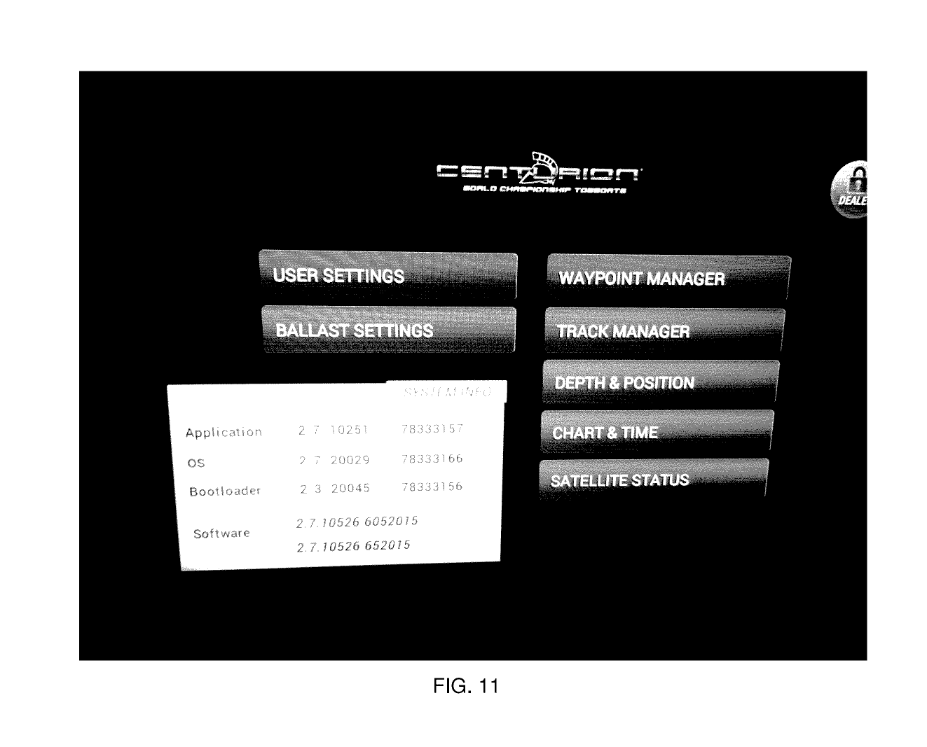

If the MENU button is pressed, the speedometer-tachometer 31 will slide to the right screen 12 along with engine data, water temp and depth. See FIG. 11. Then the left screen 11 is dedicated to menu and settings.

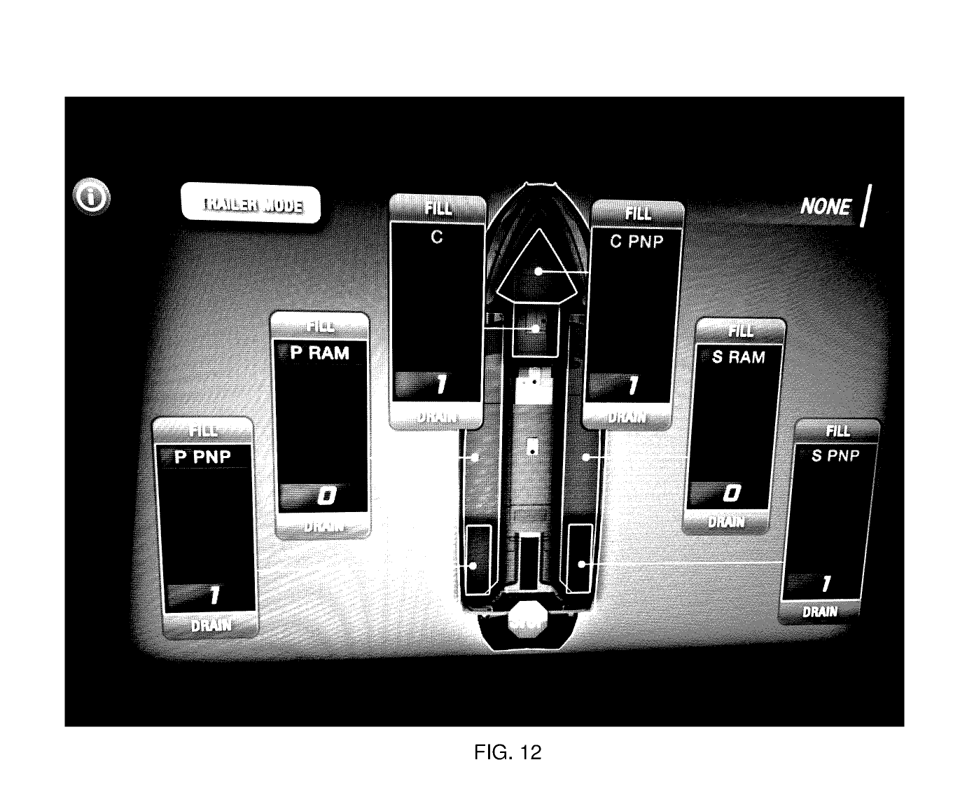

The four buttons on the frame of the right screen 12 are labeled BALLAST, RIDER, SURF and SWITCH from top to bottom, respectively. See FIG. 9A. If the BALLAST button is pressed, the speedometer-tachometer 31 will slide to the left screen 11 and an outline of the boat is displayed on the right screen 12 showing the location of each of the ballast tanks and their fill levels. See FIG. 12.

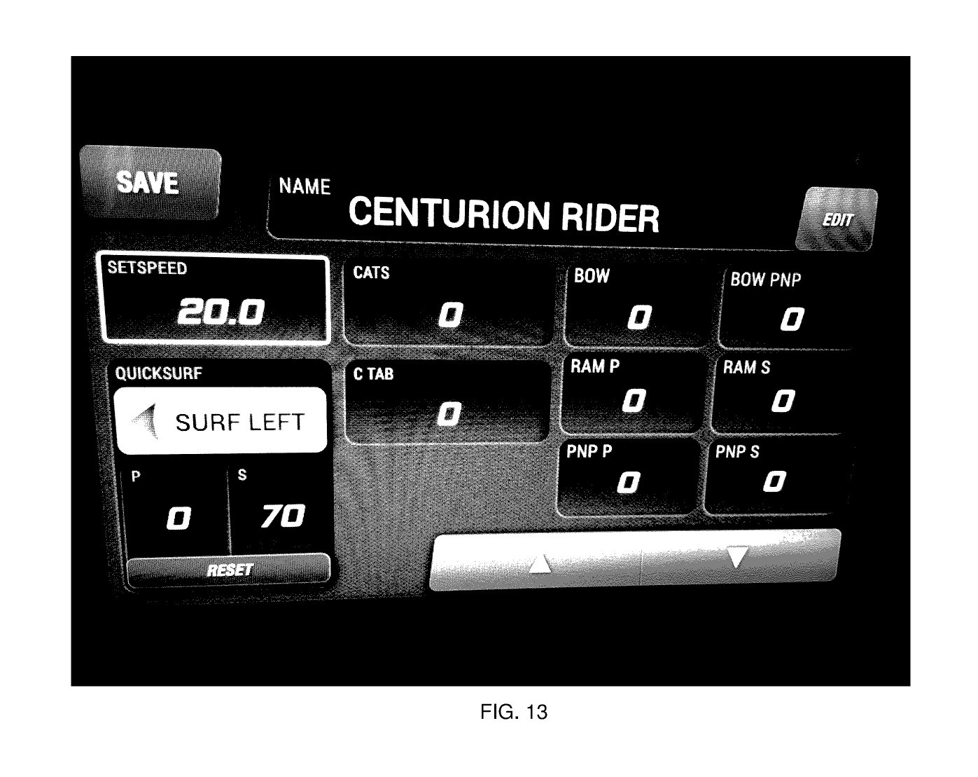

If the RIDER button is pressed, speedometer-tachometer 31 will slide to the left screen 11 and the right screen 12 will display rider data including the rider's preferred speed of the boat, CATS™ position (center fin), center wake tab position, QuickSurf™ tab position, all of the ballast amounts from 0% to 100%. See FIG. 13.

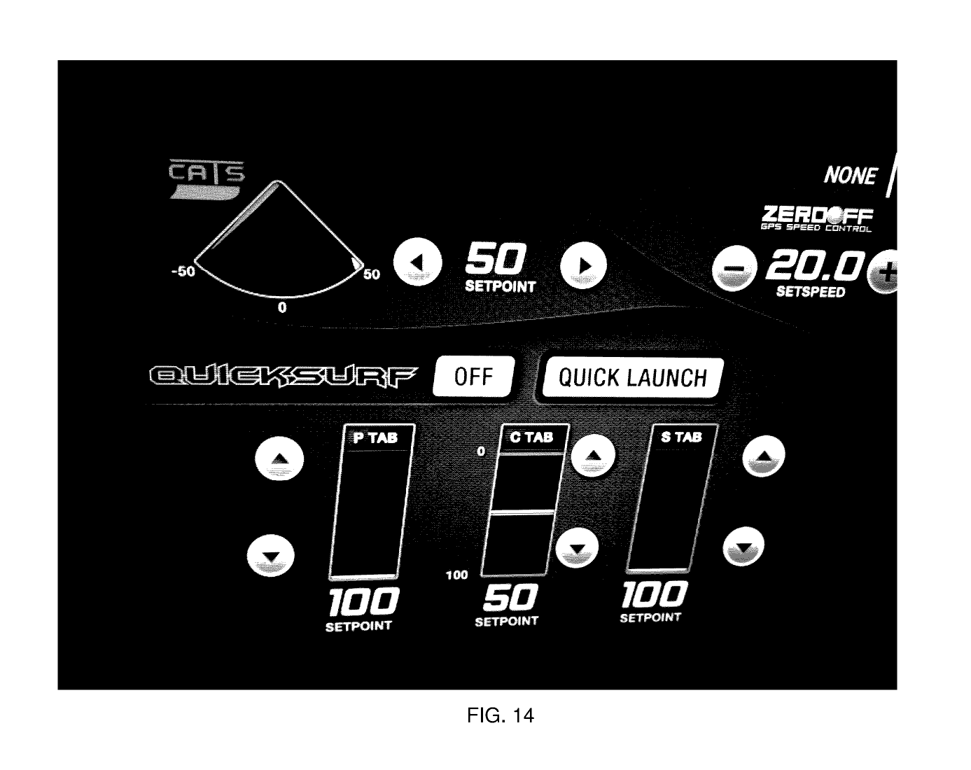

If the SURF button is pressed, the speedometer-tachometer 31 will slide to the left screen 11 and the right screen 12 will display wake equipment controls. See FIG. 14. For Centurion® boats this includes Surf, Tab and CATS positions/controls including set speed and adjust speed, surf left/surf right to adjust the Quicksurf™ tabs, center tab, CATS™ setpoint, and whether the preset for rider is on or off.

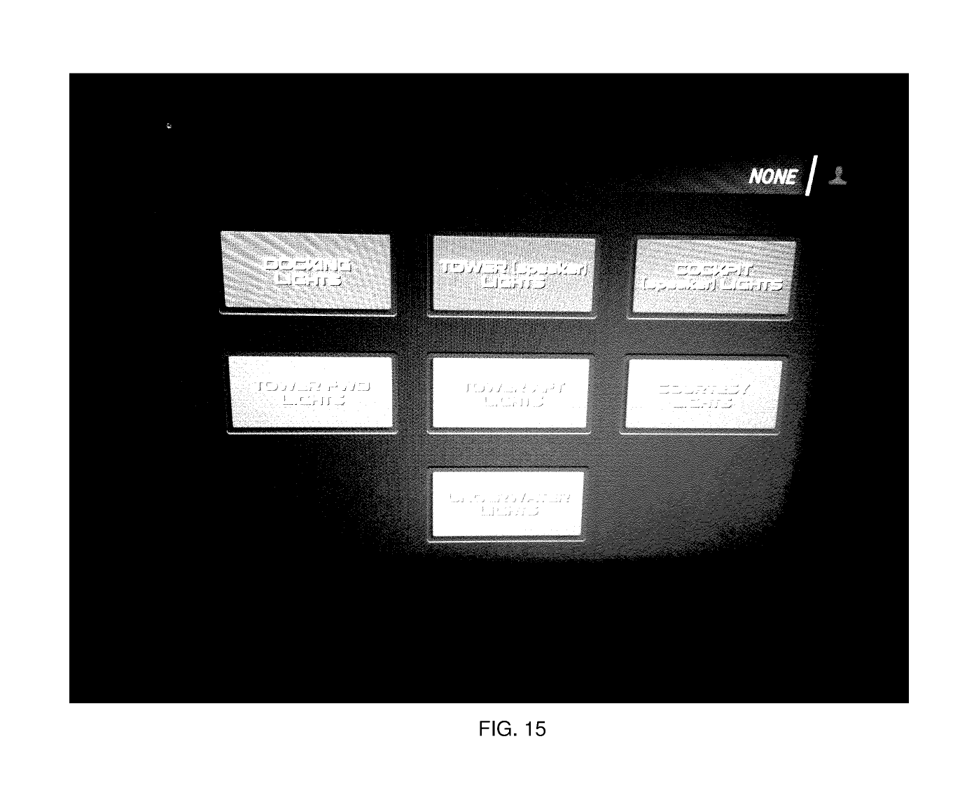

If the SWITCH button is pressed speedometer-tachometer 31 will slide to the left screen 11 and the right screen 12 will display switching controls for all lights including docking lights, tower speaker lights, cockpit speaker lights, tower lights (forward and aft), courtesy lights and underwater lights. See FIG. 15.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the claims.

I claim:

1. A method of displaying data to the boat driver while the boat is underway comprising:
a. displaying on a boat's dashboard a first state comprising:
i. displaying a first portion of a center feature on a first screen; and
ii. displaying a second portion of the center feature on a second screen;
b. displaying on a boat's dashboard a second state comprising:
i. combining the first and second portions to form a whole center feature;
ii. displaying the whole center feature on the first screen or the second screen;
c. pressing a button to change the display on the dashboard, the change comprising:
i. displaying one or more intermediate states between the first state and the second state in which additional portions of the center feature are shown on the first screen and second screen such that it appears that the first and second portions of the center feature are sliding together across the first and second displays under a mullion disposed between the first screen and second screen; and
ii. displaying additional data on the first screen or second screen.

2. The method of claim 1 further comprising pressing a button to change the display on the dashboard, the change comprising causing the center feature to disappear and displaying additional boat data on the first screen.

3. The method of claim 3 wherein the dial is speedometer.

4. The dashboard of claim 3 wherein the first portion is a tachometer and the second portion is a speedometer.

5. A method of displaying a vehicle's data on the vehicle's dashboard comprising:
a. mounting a display comprising a first screen located adjacent a second screen in the vehicle's dashboard under a frame having a mullion disposed between the first screen and the second screen;
b. displaying a first state comprising:
i. displaying a first portion of a center feature on the first screen; and
ii. displaying a second portion of the center feature on the second screen;
c. displaying a second state comprising:
i. combining the first and second portions to form a whole center feature;
ii. displaying the whole center feature on the first screen or the second screen; and
d. displaying one or more intermediate states between the first state and the second state in which additional portions of the center feature are shown on the first screen and second screen such that it appears that the first and second portions of the center feature are sliding together across the first and second displays under the mullion.

6. The method of claim 6 further comprising, while displaying the second state, displaying additional data on at least the first screen.

7. The method of claim 6 further comprising, after displaying the second state, displaying additional data on at least the first screen by pressing a button disposed in or on the frame.

8. The method of claim 6 further comprising pressing a button to cause the center feature to disappear and to display additional data.

9. The method of claim 6 further comprising displaying a dial as the center feature.

10. The method of claim 9 further comprising displaying the first portion as a tachometer and the second portion as a speedometer.

11. A dashboard for a vehicle comprising:
a. a display comprising a first screen located adjacent a second screen;
b. a mullion between the first screen and the second screen;
c. a first state of the display in which:
i. a first portion of a center feature is displayed on the first screen; and
ii. a second portion of the center feature is displayed on the second screen;
d. a second state of the display in which the first and second portions are combined to form a whole center feature which is displayed on the first screen or the second screen; and
e. one or more intermediate states between the first state and the second state in which additional portions of the center feature are shown on the first screen and second screen such that it appears that the first and second portions of the center feature are sliding together across the first and second displays under the mullion.

12. The dashboard of claim 11 wherein the center feature is a dial.

13. The dashboard of claim 12 wherein the center feature is a speedometer.

14. The dashboard of claim 13 wherein the first portion is a tachometer and the second portion is a speedometer.

15. The dashboard of claim 14 wherein the first screen and second screen are arranged side-by-side horizontally.

16. The dashboard of claim 11 wherein the mullion is made of an opaque material.

17. The dashboard of claim 11 wherein the display is integral with the structure of the vehicle and, while the vehicle is being driven by a driver, faces the driver.
